(19) United States
(12) Patent Application Publication
(10) Pub. No.: US 2008/0134070 A1
(43) Pub. Date: Jun. 5, 2008

(54) IMAGE PROCESSING APPARATUS AND IMAGE PROCESSING METHOD

(76) Inventors: Koji Kobayashi, Kanagawa (JP); Hirohisa Inamoto, Kanagawa (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/936,994

(22) Filed: Nov. 8, 2007

(30) Foreign Application Priority Data
Nov. 9, 2006 (JP) 2006-304012
Apr. 25, 2007 (JP) 2007-116070

(51) Int. Cl. G06F 3/048

(52) U.S. Cl. 715/767

(57) ABSTRACT

The user instructs a server apparatus to display thumbnails in a list. When an instruction for displaying the list is received at the server apparatus, a display screen control processing unit generates a thumbnail list display screen and transmits it to a client apparatus. The user browses the display screen and issues an instruction for changing a display magnification. The instruction is transmitted to the server apparatus as screen control data. The server apparatus changes a thumbnail list view screen in accordance with the screen control data and displays it on the display screen.

### PRIORITY

The present application claims priority to and incorporates by reference the entire contents of Japanese patent application, No. 2006-304012, filed in Japan on Nov. 9, 2006 and Japanese patent application No. 2007-116070, filed in Japan on Apr. 25, 2007.

### BACKGROUND OF THE INVENTION

1. Field of the Invention

The present invention relates to an image processing apparatus that generates a list display screen of plural images, such as a thumbnail list, with respect to image data accumulated in an image database and to an image processing method. More specifically, the present invention relates to a suitable technology for MFPs (Multi Function Printers) such as composite machines, file servers, and image processing programs.

2. Description of the Related Art

Although there are, for example, electronic filing apparatuses that computerize paper documents using input devices such as scanners, they are mainly used for business purposes where a large amount of paper documents is handled. In recent years and continuing to the present, electronic filing has been acknowledged for its handling ability and convenience even at offices because of the price-reduction of scanners, the widespread use of MFPs including a scanner function, and legislation such as an electronic document law, resulting in computerization of paper documents. Meanwhile, image information databases have been increasingly used that make a database (hereinafter simply referred to as DB) of image data generated by computerizing paper documents and document data generated by applications of a PC or the like to collectively manage the same. For example, even if it is necessary to store the original of a paper document, image information DBs are likely to be structured because of their easiness for management and searching.

As the image information DBs, there are various ones such as a large-scale type that has installed therein a server apparatus to which a large number of users make accesses, and a personal-use type formed by structuring a DB in the PC of an individual person. For example, recent MFPs come with a function of storing image data generated by computerizing paper documents in a built-in HDD (Hard Disk Drive), and image information DBs based on the MFPs have been structured.

When browsing the images of an image information DB in which plural images are accumulated, the user searches for a target image by using an image search method. In other words, if the image name (file name) of the search target image is known, a thumbnail list display is generally used. For example, when searching for document images, the user performs keyword searches and then displays the candidate images hit (selected) by the keyword in a thumbnail list. In order to search for the target image, the user employs a method of either selecting the search target image from the thumbnail list display at the end or using only the thumbnail list display from the beginning.

The thumbnail list display is such that plural reduced images are arrayed on a screen to facilitate understanding of the contents of the images. However, since the plural images are displayed on the limited screen at a time, the resolution of an individual thumbnail is generally low. When photographic images are displayed in a thumbnail list, it is relatively easy to understand the contents of the images even if they are reduced images of a low resolution. In the case of document images mainly consisting of characters, on the other hand, it is difficult to discriminate the characters in reduced images one from another and understand the contents of the document images. Accordingly, it is necessary for the user to zoom in on an individual document image with a viewer function or the like in order to confirm the same when searching for document images, which reduces operability during searching. Particularly, in the case of a client/server system via a network, it is necessary for the user to newly transfer image data of a high resolution when displaying images with the viewer, which causes a long processing time for confirming the plural images and remarkably-reduced search efficiency.

Since it takes time to display a large number of thumbnails in the thumbnail list display, the client/server system via a network, in particular, reduces the number of displays viewable at a time and changes a screen as if a page is turned over, to thereby reduce standby time until the thumbnails are displayed. In this case, however, the number of thumbnails capable of being displayed on the screen is small, and so it is necessary to turn over a page (change a screen) many times. Additionally, since the whole picture of the images included in the thumbnail list display cannot easily be recognized, a desired image may not be found in some cases even if the thumbnail list display is viewed until the last page. As a result, the search efficiency is further reduced. As described above, if the number of thumbnails displayed in the screen (page) is increased, it takes time and reduces the search efficiency.

Meanwhile, when the thumbnail list display is generated in the image information DB, that is, every time the display screen is created, dynamic thumbnails are not created from stored original images. Generally, there is employed a method of previously holding (accumulating) images for thumbnails generated by reducing the original images and using the same. This method is excellent in processing speed. For example, when HTML (Hyper Text Markup Language) or the like is used to create the display screen of a thumbnail list in the server/client system, the server does not generally create a bitmap display screen. The server creates only a link based on the image (file) name displayed in the HTML document, and the HTML document is developed (rendered) by browser software on the side of the client to create a so-called bitmap display screen. In this case, however, it is necessary to transfer all the thumbnail images to be displayed on the display screen from the server to the client (all the thumbnail images are generally transferred even if a part protruding from the screen exists) regardless of the size of thumbnails (usually designated by the server) to be displayed on the display screen. Therefore, if the number of thumbnails displayed on a screen is increased, the amount of data to be transferred increases accordingly. Additionally, since a small amount of data is transferred many times, data transfer efficiency is reduced to thereby take time for performing screen display on the client. Generally, since the length of a packet is fixed at data transfer and different files are not put in the same packet, redundant transfer data appear in small files. If the transfer data of the small files are increased, the redundant data are prominent to thereby reduce the transfer efficiency. Generally, if the number of thumbnails to be displayed is increased in the server as well, the workload such as disk access increases.

Accordingly, there has been proposed the search method of Japanese Patent No. JP-A-2004-258838 in order to solve the above problems. In other words, target information is searched for with simple operations, namely, a map display procedure and a thumbnail detailed display procedure. According to the map display procedure, thumbnails are arranged on a two-dimensional map and displayed. Furthermore, according to the thumbnail detailed display procedure, when the user specifies points in a specific small area from among the plural small areas formed by dividing a map, a small area group centered on the specific small area is defined as an enlargement target area. Then, the thumbnails arranged in the enlargement target area are enlarged to display contents in detail.

However, the method disclosed in the above Patent Document 1 switches a display between thumbnails and a detailed display in a binary manner. Therefore, if the position of a search target image cannot be understood on the map, it is necessary to enlarge and display images one by one, which may cause an insufficient enlargement factor. Furthermore, if a large number of thumbnails to be displayed exist on the map, it is impossible to overlappingly display the thumbnails. As a result, the size of thumbnails is reduced to make the thumbnail list useless. Moreover, as described above, if the number of thumbnails displayed in a list is increased, it takes much time to display them.

### SUMMARY OF THE INVENTION

An image processing apparatus and image processing method are described. In one embodiment, an image processing apparatus generates a list display screen for displaying a thumbnail, wherein the list display screen comprises: a thumbnail list view of which display magnification is changeable; a list view window for displaying at least part of the thumbnail list view; and plural of the thumbnails of which size or resolution is changeable in accordance with the display magnification.

### BRIEF DESCRIPTION OF THE DRAWINGS

FIG. 1 is a system configuration of a first embodiment of the present invention;

FIG. 2 shows a configuration for both a server apparatus and a client apparatus of the first embodiment;

FIG. 3 shows an operations flowchart at image registration of the first embodiment;

FIG. 4 shows a relationship between a thumbnail and the size of a long side thereof;

FIG. 5 shows an operations flowchart at image searching of the first embodiment;

FIGS. 6A and 6B show examples of a thumbnail list display screen of the first embodiment;

FIG. 7 shows an operations flowchart of the server apparatus at the generation of the display area screen of a thumbnail list view;

FIGS. 8A through 8D show enlarged display examples of the first embodiment;

FIGS. 9A and 9B describe the effect of the first embodiment;

FIG. 10 shows a system configuration of a second embodiment;

FIG. 11 shows an operations flowchart at the image registration of the second embodiment;

FIGS. 12A and 12B show examples of a thumbnail list display screen of the second embodiment;

FIG. 13 shows a system configuration of a third embodiment;

FIG. 14 shows a flowchart at the generation of a display area screen of a thumbnail list view of the third embodiment;

FIG. 15 shows each registration image and tiles;

FIG. 16 shows a block diagram of the compression coding processing with JPEG-2000;

FIG. 17 shows a relationship between a decomposition level and a resolution level;

FIG. 18 shows a relationship between a tile, a precinct, and a code block;

FIG. 19 show a relationship between a bit plane and a sub bit plane;

FIG. 20 shows a configuration of a code stream; and

FIGS. 21A and 21B show coding orders of a layer progression and a resolution progression.

### DETAILED DESCRIPTION OF THE PREFERRED EMBODIMENTS

An embodiment of the present invention has been made in view of the above problems and may provide an image processing apparatus that displays thumbnails in a list and improves operability and search efficiency when the user searches for a search target image from the list and an image processing method.

According to an embodiment of the present invention, there is provided an image processing apparatus that generates a list display screen for displaying a thumbnail. In the image processing apparatus, the list display screen comprises a thumbnail list view of which display magnification is changeable; a list view window for displaying at least part of the thumbnail list view; and a plurality of the thumbnails of which size or resolution is changeable in accordance with the display magnification.

### First Embodiment

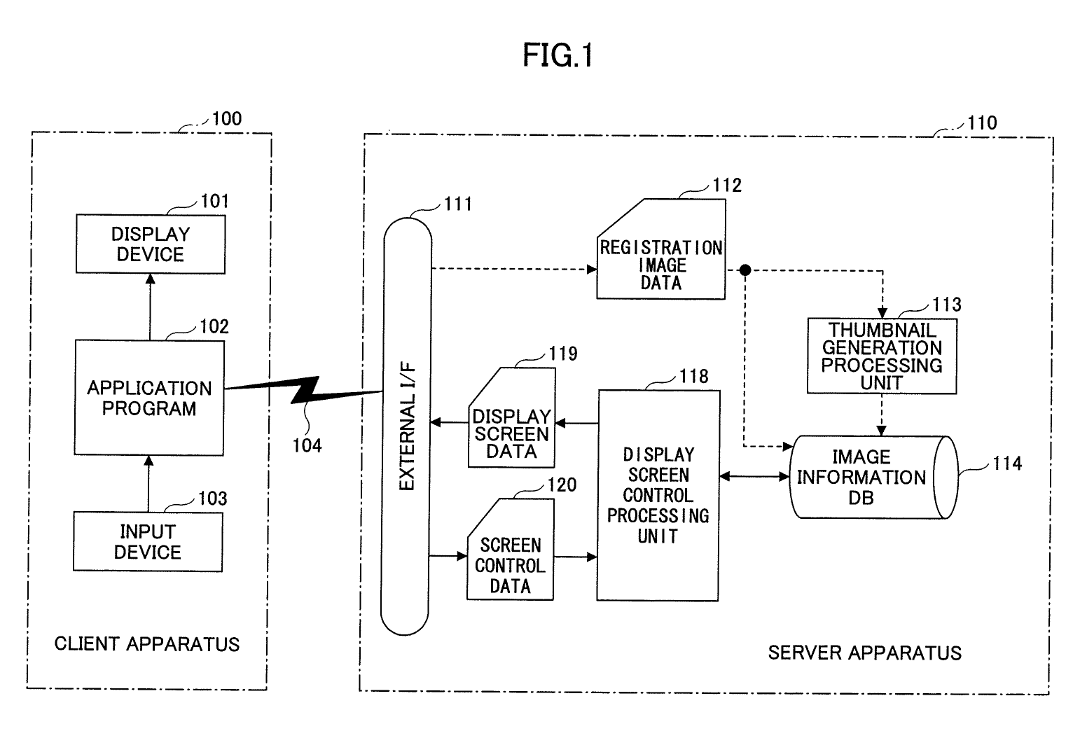

FIG. 1 shows a system configuration of a first embodiment of the present invention. In FIG. 1, reference numeral 100 denotes a client apparatus, i.e., a mobile apparatus such as a personal computer (hereinafter referred to as PC), a PDA, and a mobile phone. Reference numerals 101, 102, 103, and 104 are a display device such as a monitor; an application program that interprets the instructions from the user, communicates with a server apparatus 110, and controls the display device 101; an input device such as a keyboard and a mouse that serves as a unit for inputting the instructions from the user; and an external communications path such as a LAN and the Internet, respectively.

Reference numeral 110 denotes the server apparatus that performs the image classification in accordance with the command from the client apparatus 100 and outputs the results of the image classification to the client apparatus 100. Reference numeral 111 denotes an interface (hereinafter referred to as external I/F) with the external communications path 104. Reference numeral 112 denotes registration image data to be registered in an image information DB 114. Reference numeral 113 denotes a thumbnail generation processing unit that scales the registration image data 112 to a predetermined size or smaller to generate plural thumbnail images. Reference numeral 114 denotes the image information DB that accumulates the image data of the registration image data 112 and the thumbnail image data thereof. Reference numeral 118 denotes a display screen control processing unit that generates a display screen to be displayed in the client apparatus 100 and controls the display screen in accordance with the content of screen control data 120. Reference numeral 119 denotes display screen data to be displayed on the display device 101 of the client apparatus 100. Reference numeral 120 denotes the screen control data specified and input by the client apparatus 100. In FIG. 1, dotted lines and solid lines represent the flow of data at image registration and that at the generation of a thumbnail list display screen, respectively.

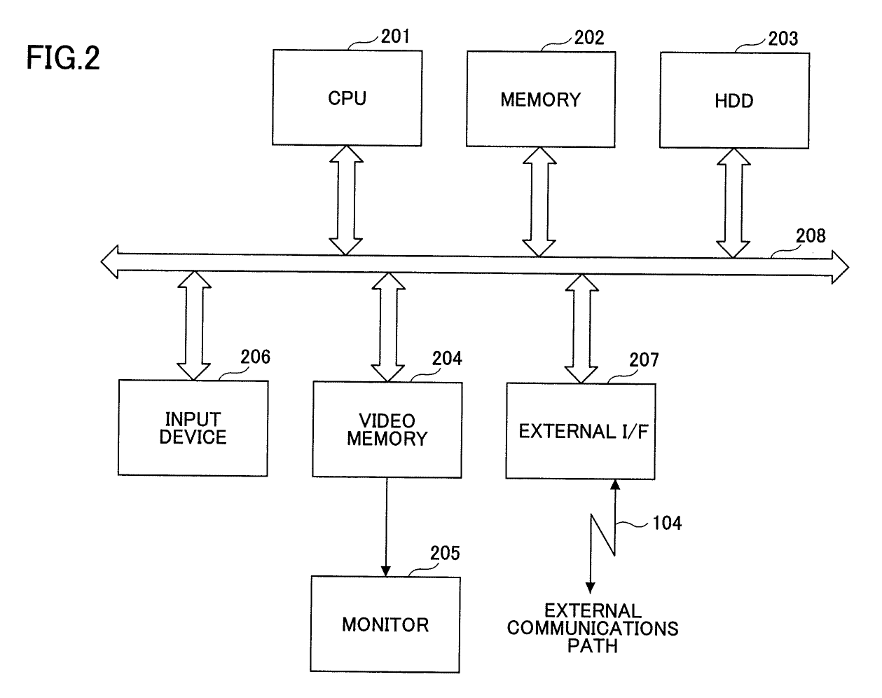

FIG. 2 shows a configuration for both the server apparatus 110 and the client apparatus 100. In FIG. 2, reference numeral 201 denotes a CPU that performs calculation and processing in accordance with a program; reference numeral 202 denotes a volatile memory used as a work area in which data such as a program code and coded data of images are temporarily stored and maintained; and reference numeral 203 denotes a hard disk (hereinafter referred to as HDD) used to store and accumulate image data and programs, and maintains the image information DB 114. Reference numeral 204 denotes a video memory as a data buffer for use in displaying on a monitor 205. The image data written in the video memory 204 are regularly displayed on the monitor 205. Reference numeral 206 denotes an input device such as a mouse and a keyboard; reference numeral 207 denotes an external I/F that transmits and receives data through the external communications path 104 such as the Internet and a LAN; and reference numeral 208 denotes a bus for connecting each of the components together.

This embodiment exemplifies a case in which the server apparatus 110 is composed of a server computer and processing such as display screen generation is implemented by software. In other words, the processing in the server apparatus 110 is implemented by an application program (not shown). The embodiments of the present invention are not limited to this. The processing may be implemented by hardware in an apparatus such as a MFP, or the configuration of FIG. 1 may be applied to an apparatus such as a PC and a MFP without employing the server and client configuration.

Next, a description is made of an operations outline of this embodiment. The system of the first embodiment is roughly divided into two operations. One is an operation of registering images and the other is an operation of “using the images of the DB,” i.e., the operation of searching for, browsing, and acquiring (downloading from the screen apparatus) a desired image. In order to use an image, the user first searches for a desired image, browses it by using a viewer as an application, and then downloads it into his/her PC. Furthermore, there are image search techniques such as keyword search processing and similar image search processing. In this embodiment, an operation of searching for a search target image from a thumbnail list display, which is performed after the keyword search processing and the similar image search processing, is a search processing target operation for simplicity of description. Note, however, that there is also a case in which an image is searched for only from a thumbnail list display without performing the keyword search processing and the similar image search processing.

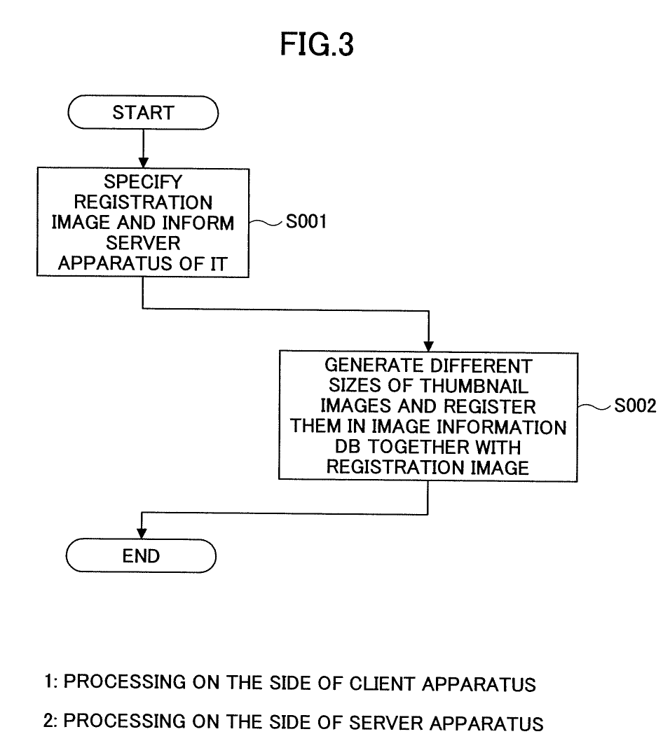

FIG. 3 shows an operations flowchart at the image registration. Referring to FIGS. 1 (the dotted lines represent the operation at image registration) and 3, a description is made of the operation of registering images.

In step S001, the user issues an instruction for registering image data and specifies the registration image data 112 to be registered from the client apparatus 100 to the server apparatus 110 through the application program 102.

In step S002, the registration image data 112 are input to the server apparatus 110 through the external communications path 104 and registered in the image information DB 114 via the external I/F 111 where an ID is added together with accompanying meta-information such as a file name. At the same time, the thumbnail generation processing unit 113 reduces the registration image data 112 to generate different sizes of “plural thumbnail images” a predetermined size or smaller and registers them in the image information DB 141 after adding the IDs to them. If the registration image data 112 are plural pages of image data, thumbnails are generated on a page-by-page basis.

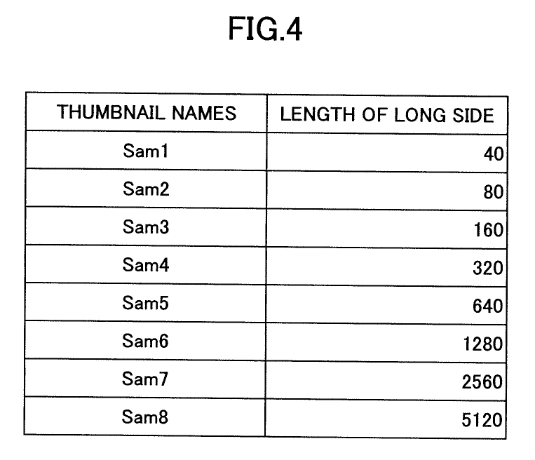

In this embodiment, plural thumbnail images different in size for each registration image are generated. As a method of generating a thumbnail, for example, the length of the long side of the thumbnail is defined for each thumbnail having a different size as shown in FIG. 4. If the length of the long side of an original image is greater than the length of the long side of the thumbnail, the registration image data 112 may be reduced to generate the thumbnail having the long side of the size involved. Note that the short side of the thumbnail is reduced while keeping the same ratio of the short side to the long side.

For example, where the image size of the input registration image data 112 is 4000 pixels long by 2000 pixels wide, seven different sizes of thumbnails Sam1 through Sam7 are generated. In this case, the length of the long side of the thumbnail is the size shown in FIG. 4, while that of the short side thereof is half the length of the long side. In this embodiment, the size of the thumbnail is defined according to the number of pixels, but resolution of the thumbnail may be changed.

In the image information DB, the accompanying meta-information such as an ID and a file name can easily be registered, managed, and searched for by the use of a general-purpose RDB (relational database). Furthermore, thumbnails and original image data may be compression-coded and accumulated as required and be configured to be linked from the meta-information so that they can be read. Furthermore, if meeting the above function, the image information DB 114 may establish and accumulate a hierarchical data structure by using a language such as XML (Extensible Markup Language) or accumulate it as a DB for each different server. For the image registration, image data may be directly registered in the server apparatus 110 from an image input device such as a scanner and a digital camera.

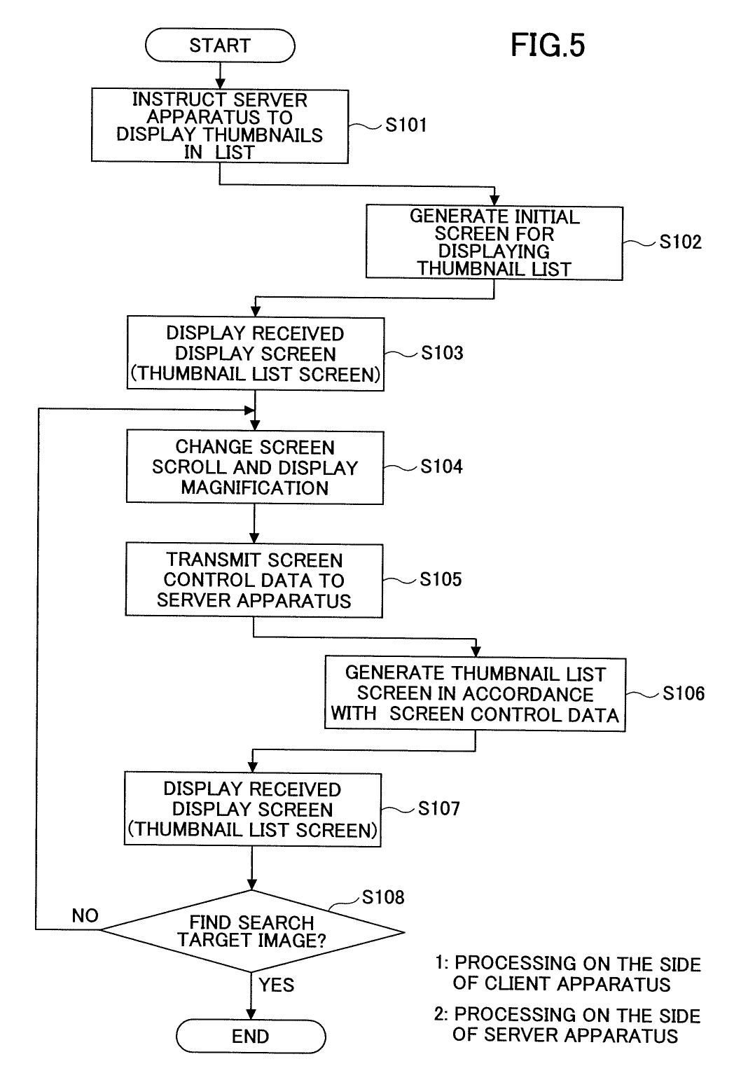

FIG. 5 shows an operations flowchart at image searching.

In step S101, the user instructs the server apparatus 110 to display thumbnails in a list by using the application program 102 of the client apparatus 100.

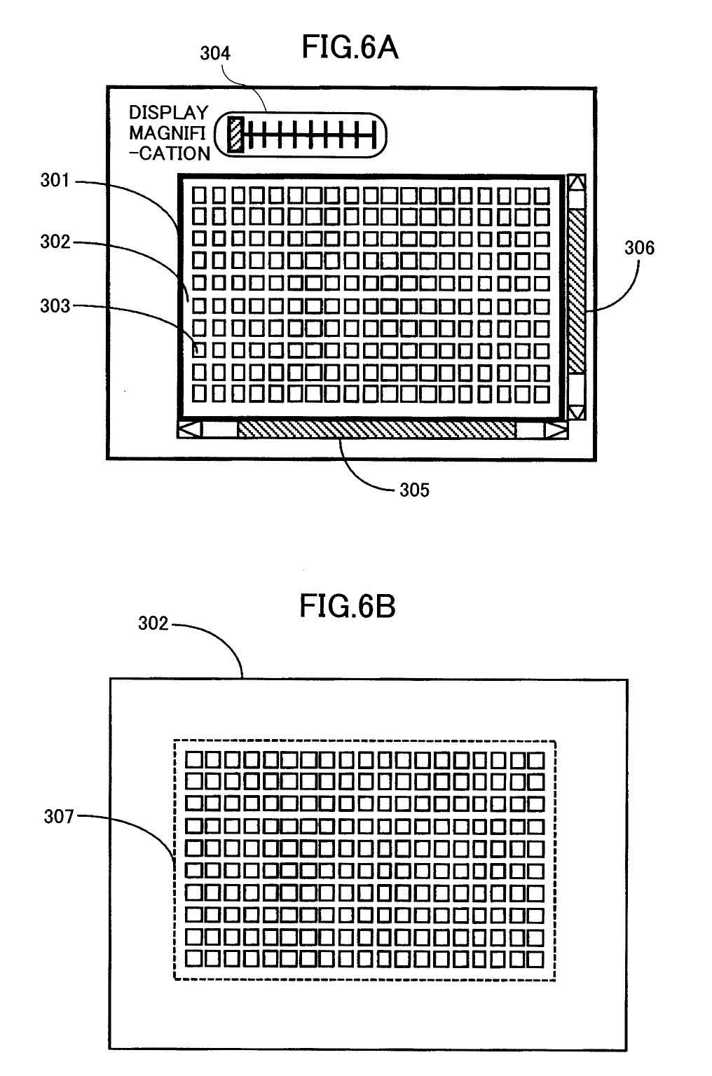

In step S102, when the instruction for displaying the list is received at the server apparatus 110, the display screen control processing unit 118 generates an initial screen for displaying a thumbnail list as shown in FIG. 6A. FIG. 6A shows an example of the thumbnail list display screen. In FIG. 6A, reference numeral 301 denotes a window defining the display area of a thumbnail list view 302. Reference numeral 302 denotes the thumbnail list view as a display frame of thumbnails. Reference numeral 303 denotes an individual thumbnail (each rectangular cell represents a thumbnail). Reference numeral 304 denotes a slider for setting the display magnification of the thumbnail list view. Reference numeral 305 denotes a slider for scrolling the thumbnail list view in the horizontal direction. Reference numeral 306 denotes a slider for scrolling the thumbnail list view in the vertical direction.

The thumbnail list display screen of this embodiment is roughly composed of two screen structures. One is the thumbnail list view 302 and the other is the frame of a user interface part and an outer frame part. The application 102 of the client apparatus 100 synthesizes these two frames to generate a display screen for the display device 101. As a result, the screen of FIG. 6A is generated. FIG. 6B shows the thumbnail list view 302 in which reference numeral 307 denotes a display area representing the boundary of the window 301.

The display screen control processing unit 118 generates the two types of display screens as described above. However, since the outer frame only serves to change the display magnification of the thumbnail list view 302 and the position of the sliders 305 and 306 of the display area, the description thereof is omitted. Here, the screen generation of the thumbnail list view 302 is specifically described.

When generating the initial screen, the display screen control processing unit 118 sets the display magnification (the lowest magnification in FIG. 6A) and the display area 307 of the thumbnail list view 302 to a predetermined value in order to generate the thumbnail list view 302 and transmit, together with the outer frame, the generated thumbnail list view 302 as the display screen 119 to the client apparatus 100 via the external communications path 104 through the external I/F 111.

Although the thumbnail list view 302 becomes the screen as shown in FIG. 6B, it is not necessary for the display screen control processing unit 118 to hold such images. It is only necessary for the display screen control processing unit 118 to hold the position information (coordinate information) of an individual display image and the ID information thereof. Furthermore, the thumbnail list view 302 transmits only the images of the display area 307 to the client apparatus 100. The generation of the thumbnail list view 302 is described later. Furthermore, although the center of the screen is enlarged as the display magnification increases, it is necessary to provide the margin of the screen of the FIG. 6B in order to enlarge thumbnails positioned at the end.

As the generation method for the display screen and the communication method between the server apparatus 110 and the client apparatus 100 described above, various techniques are available. As a commonly used one, a World-Wide-Web based technique using the server apparatus 110 as a Web server can perform these methods. It is possible for the display screen 119 to be written in HTML and a general Web browser to be used as the application 102. Furthermore, in this embodiment, the scrolling sliders for changing the display magnification and the display area are provided in the screen, but a function equivalent to the sliders may be provided to an input device such as a mouse of the client apparatus 100.

Now, let us return to FIG. 5. In step S103, the application program 102 of the client apparatus 100 develops (rendering) the display screen 119 to be displayed on the display device 101.

In step S104, the user using the client apparatus 100 browses the display screen data 119, operates the sliders 305 and 306 for changing the display area to search for a search target image, and operates the slider 304 for setting the display screen magnification to change the display magnification. Accordingly, the user gives an instruction for changing the screen scroll and the display magnification. The operation of the sliders is performed by the use of the input device 103 (not shown).

In step S105, the instruction for changing the screen scroll and the display magnification is converted into display-area data and display-magnification data as the screen control data 120 and transmitted to the server apparatus 110.

In step S106, upon receipt of the screen control data 120, the server apparatus 110 changes the thumbnail list view screen as described below. In step S107, the display screen 119 after being changed is displayed on the display device 101 in the same manner as step S103. In step S108, if the user cannot find the search target image, the operations of steps S104 through S107 are repeated.

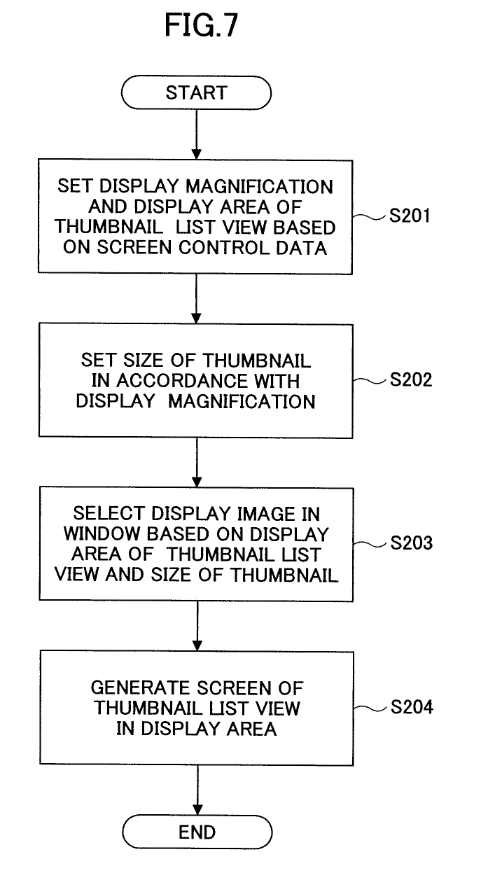

FIG. 7 shows an operations flowchart of the server apparatus 110 at the generation of the display area screen of a thumbnail list view. Referring to FIG. 7, a description is made of the change processing of the thumbnail list view screen (step S106).

In step S201, when the screen control data 120 are input from the client apparatus 100, the display magnification and the display area 307 of the thumbnail list view are set. For an initial screen, the predetermined setting values are stored in the server apparatus 110.

In step S202, the size of a thumbnail to be displayed is set in accordance with the display magnification. In other words, the setting of the size of the thumbnail means to set the type of the thumbnail (Sam1 through Sam8 of FIG. 4 or original image) to be used in the thumbnail list view screen. For example, if the length of the long side of the thumbnail corresponding to the display magnification is “40,” the thumbnail Sam1 of FIG. 4 is selected. Furthermore, instead of using the display magnification selected and set by the user, the user may directly set the size of the thumbnail.

If the size of the thumbnail corresponding to the display magnification falls between the values of FIG. 4, the type of the thumbnail may be selected according to a prescribed rule. For example, the thumbnail of a size the closest to the corresponding one may be selected or that of a size smaller than the corresponding one may be selected (which brings about an effect of reducing an image transfer amount).

In step S203, the type of the thumbnail corresponding to the image data included in the display area 307 of the thumbnail list view is selected and determined.

In step S204, as for the selected thumbnail, the image in the display area of the thumbnail list view is generated. There is a method of converting the screen data of the thumbnail list view into bitmap data. However, since a method of writing the coordinate information of images and the link information thereof in a structured document is generally used in HTML, it is necessary to transfer the data of each thumbnail image of the structured document and the display area from the server apparatus 110 to the client apparatus 100.

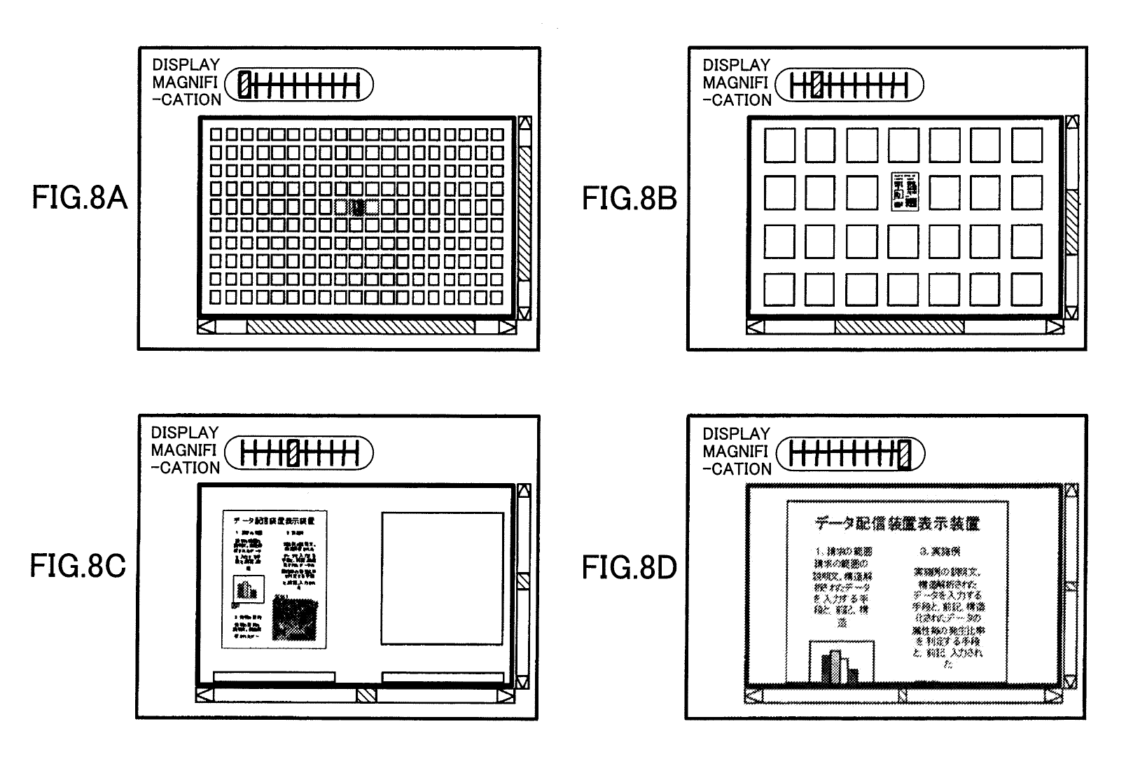

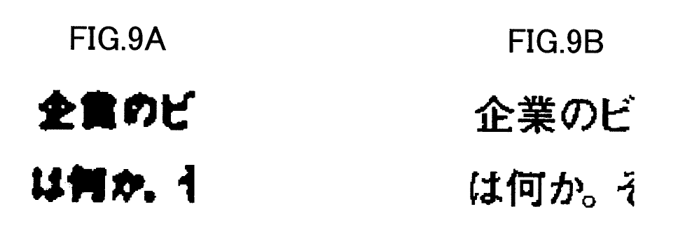

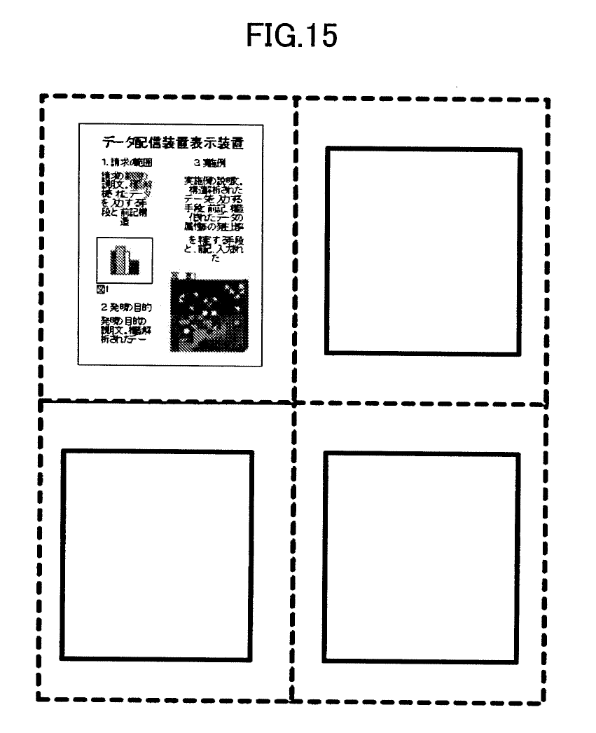

FIGS. 8A through 8D show enlarged examples displayed on the display device 101 of the client apparatus 100. The user displays on the center of the screen a candidate image for the search target image out of plural thumbnail images by using the sliders 305 and 306 (FIG. 8A), compares it with surrounding images in the process of gradually increasing an enlargement factor, and confirms whether it matches the search target image while seeing the content of the image (FIGS. 8B and 8C). If it is determined that the candidate image does not match the search target image, the user reduces the display magnification and searches for another candidate image. If the candidate image matches the search target image, on the other hand, the user can confirm the content of the image in detail by increasing the display magnification while displaying the thumbnail list view screen (FIG. 8D). Note that Japanese characters as seen, e.g., in FIGS. 8C and 8D are for illustrative purpose, and so they do not have a particular meaning in the present specification. In the following description, the same applies to other figures such as FIGS. 9A, 9B, and 15.

As described above, in the method of searching for an image from the thumbnail list view, this embodiment makes it possible to smoothly and continuously search for a target image while confirming the contents of plural images without opening another window such as a viewer, thereby improving operability. Furthermore, since the size of a thumbnail (or resolution) is changed according to the display magnification to alter the fineness degree of the thumbnail in this embodiment, it is possible to confirm the content of an image without lowering its quality every time the enlargement factor is increased. For example, as a simple method of enlarging an image, an individual thumbnail is typically enlarged for each image. However, this method makes it difficult to discriminate a character image or the like because a fine image cannot be obtained even if the image once reduced in size is enlarged. FIGS. 9A and 9B show an enlarged image according to the typical method and an image according to the embodiment of the present invention, respectively.

Furthermore, since plural thumbnail images different in size for each image are held in this embodiment of the present invention, it is not necessary to transfer a large size image just for confirming the content of the image. That is, since it is only necessary to transfer the thumbnail image of the size adapted to the display magnification, the amount of data to be transferred until the confirmation of the content of the image is small and the transfer time is reduced, to thereby improve search efficiency. Furthermore, when a screen with a large number of thumbnails is displayed, it is possible to use a thumbnail image smaller than the typical one. Therefore, in this case, the transfer time is further reduced to improve search efficiency. Furthermore, since only the data of the thumbnail image in the display area of the screen are transferred, the transfer time is also reduced for a large size thumbnail image to improve search efficiency.

In the first embodiment, there is described the method of constituting the thumbnail list view with the structured document and the link using such as HTML. If there are many thumbnails in the display area as in the case of low magnification, however, the image at the low magnification is generated at the image registration, accumulated in the image information DB 114 together with images and thumbnail data, and processed as image data. Accordingly, the data transfer time is further reduced, the amount of data to be processed by the server apparatus 110 becomes small, and the time waiting for the display of the image on the screen is reduced, so that search efficiency is improved.

### Second Embodiment

Although the arrangement of thumbnails is not particularly taken into consideration in the first embodiment, it is more efficient to search for a target image if there is employed the arrangement in which images having the same attribute are placed near the target image in searching for the image from a thumbnail list view. Accordingly, in this embodiment, image classification processing is performed to represent modes of classification on the screen in order to improve search efficiency. In the following description, a document image frequently used at offices is referred to as a target image. Note that although processing is performed with one image data group in this embodiment, the present invention is not limited to this.

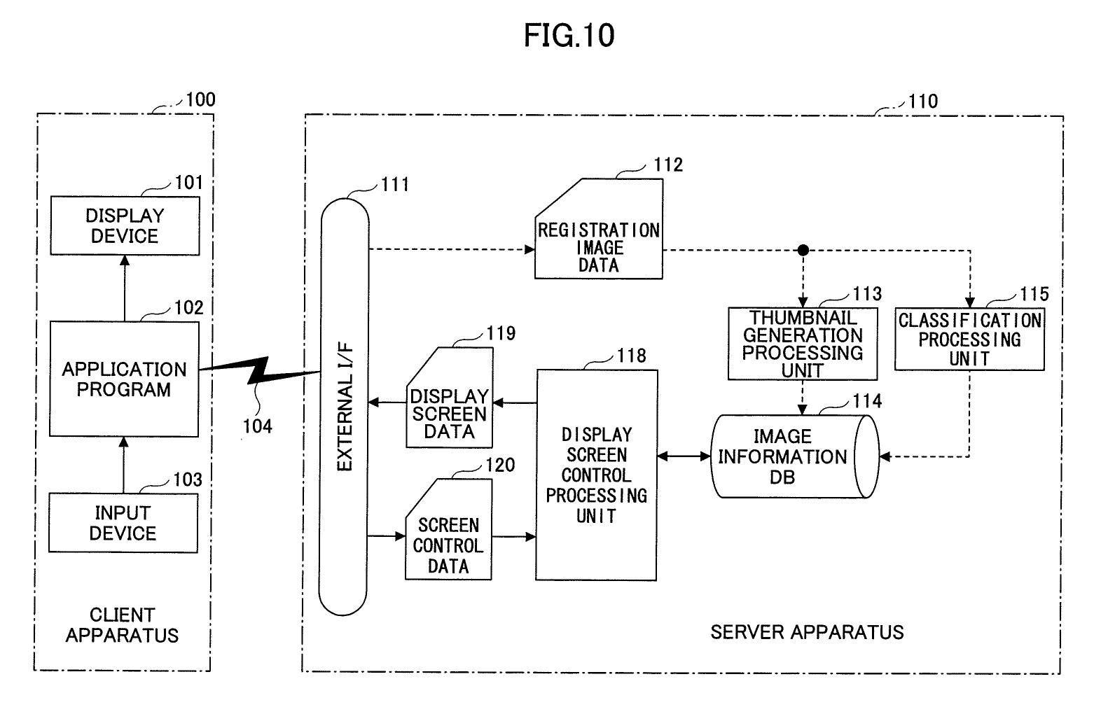

FIG. 10 shows a system configuration of the second embodiment. In FIG. 10, reference numeral 115 denotes a classification processing unit that calculates the characteristic amount of an image and classifies the image into a predetermined category, and reference numeral 114 denotes an image information DB in which classification categories and the like are stored. Since the other elements are the same as those of FIG. 1, they are not described below.

(Classification Processing)

Although various clustering and classification processing techniques for document images have been proposed, here is exemplified a classification processing technique as described below. For example, plural characteristic amounts (color characteristic amount, shape characteristic amount, and layout characteristic amount) are calculated from a registered document image. In other words, the color characteristic amount relating to the color of an image such as the background color and the color distribution of a document image is calculated from the registered document image, and the shape characteristic amount relating to the shape of an image such as the edge and the texture of a document image is calculated from the registered document image. For calculation of the layout characteristic amount, an image is divided into objects on an image-element-by-image-element basis, the attributes of the objects are determined to obtain layout information, and then an arrangement, an area ratio, or the like is calculated for each object attribute (e.g., a title, a character, a graphic, a picture, a table).

With the plural characteristic amounts, the following plural category identification processes are performed. The category type for identification consists of color category identification, shape category identification, layout category identification, and document type identification. In other words, the color category identification is that the background color, the most frequently used color, or the like as the color characteristic amount is input as a representative color and classified into an approximate one of the categories such as red, blue, green, yellow, and white. The shape category identification is such that a document image is classified into a category based on the similarity of plural characteristic amounts such as the edge and the texture of the image. The layout category identification may classify an image in the same manner as the shape category identification. For identification of a document type, an image is classified into a category by the use of the characteristic of the document type such as column setting from among plural layout characteristic amounts in a two-way search manner. Alternatively, pairs of characteristic amount data of layouts and answer data of document types to be identified are previously learned as teacher data by a learning machine for machine learning or the like. The document type is thus identified based on the layout characteristic amount using the learning data.

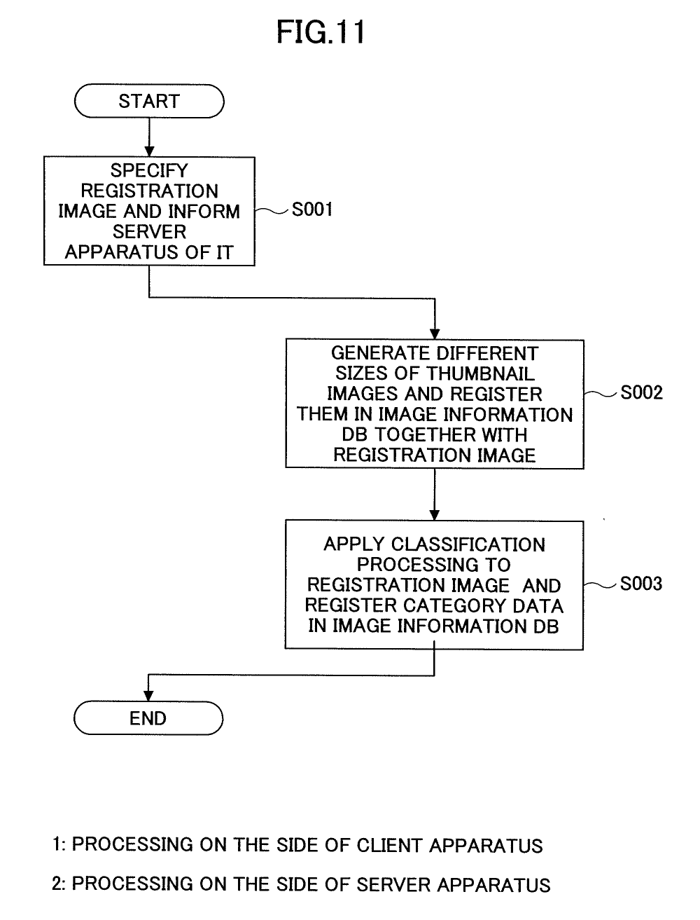

In this embodiment, the classification is performed based on the above methods. FIG. 11 shows a flowchart at the image registration in this embodiment. Here, only step S003 different from the first embodiment is described.

In step S003, the registration image data 112 are subjected to the classification processing with the classification processing unit 115, and respective category data are registered in the image information DB 114 together with other meta-information.

The classification categories set at the image registration are used to arrange an image on the thumbnail list view 302. Since the operations thereof are the same as those of the first embodiment, they are not described. Below, a description is made of the thumbnail list view of this embodiment.

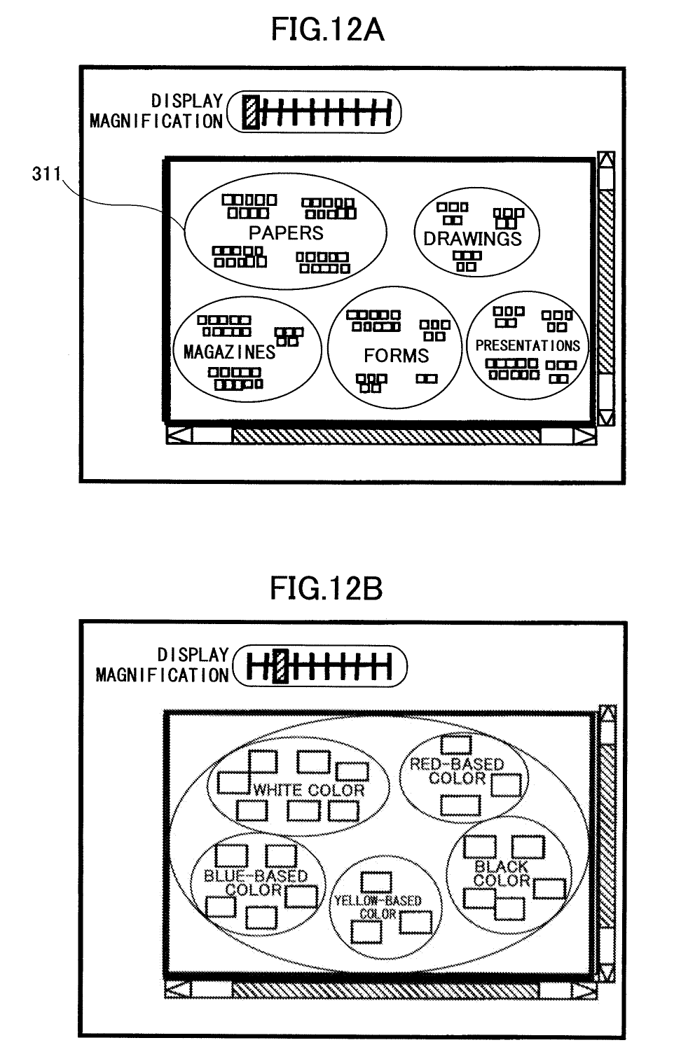

FIG. 12A shows an example of the initial screen of the thumbnail list screen. In FIG. 12A, reference numeral 311 denotes the boundary of the classification category. This embodiment shows where the document classification processing is performed at the image registration and an image is classified into a category based on the category information generated by the document classification processing. In the case of this embodiment, an image is classified into a category based on the document type as a large group, and the large group is further classified into a medium group and a small group based on a color, a shape, a layout, or the like. The medium group and the small group may be varied to suit the document type. For example, as shown in FIG. 12B, if the document type is classified into presentation material as the large group, color classification by which an image is classified into a category based on the background color may be used as the medium group. Furthermore, layout classification and shape classification may be used as the small group. Such an arrangement on the thumbnail list view may be generated by the display screen control processing unit 118 when the initial screen is generated at step S102 of FIG. 5. However, if the arrangement is determined at the image registration and the information on the arrangement (coordinates of each image on the thumbnail list view) is held until then, it is possible to reduce the processing time until the image is displayed. Note that it is also possible to use a date and an ID order instead of the classification categories.

In FIGS. 12A and 12B, although characters are used to indicate the name of each category, they may be eliminated. In some cases, it is difficult to assign a category name to the classifications based on a layout or a shape. However, even if the category name is not assigned to the classifications, the user can determine the category by seeing the aggregation of thumbnails. According to the embodiment of the present invention, the change of the display magnification allows for the reference of the contents of plural images at the same time, which helps the user understand the contents of thumbnail groups. Furthermore, where the size of thumbnails is fixed and the classification is expressed by plural thumbnails, it is not possible to display plural images on a screen. In this case, it may also be possible to use dots, colors, pixel densities, or the like to pseudo-express the classification instead of using thumbnails.

As described above, since the classification is displayed on the thumbnail list view according to this embodiment of the present invention, the images having the same attribute are arranged adjacent to one another. In this case, it is possible to enlarge the display magnification without lowering the image quality. As a result, document images are efficiently refined.

### Third Embodiment

In the first and second embodiments, plural thumbnail images different in size (or resolution) for each registration image are generated, but the data amount accumulated in the image information DB is caused to be increased. Accordingly, in this embodiment, an original image is compressed by hierarchical coding to reduce the data amount stored in the image information DB.

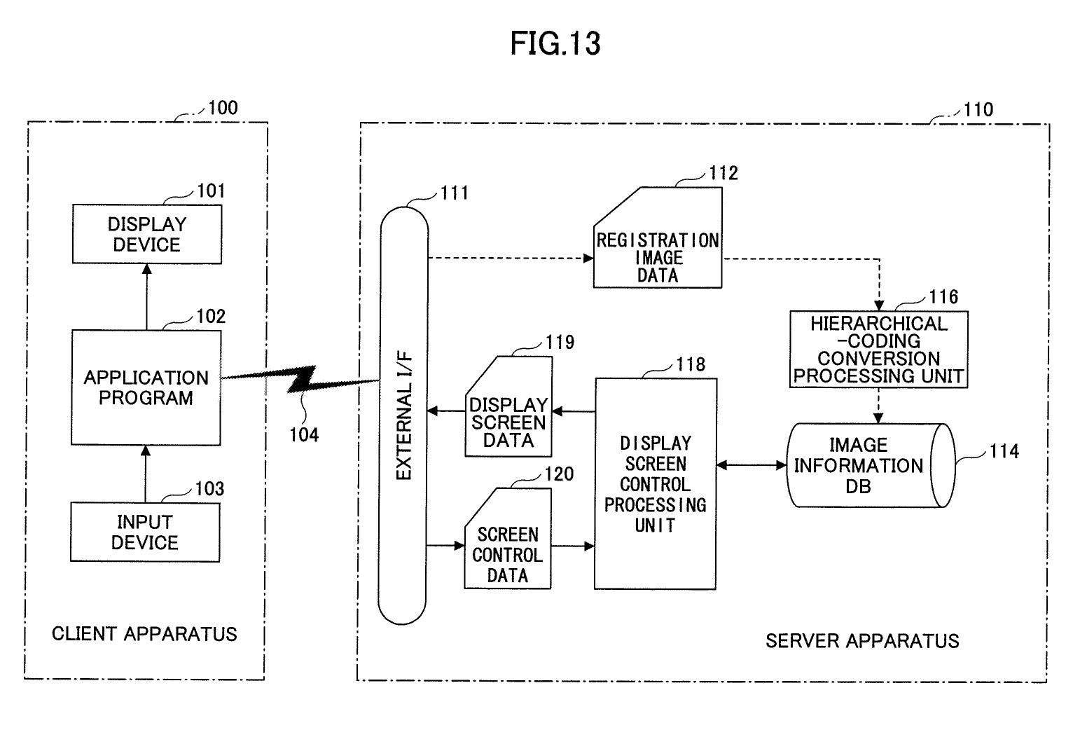

FIG. 13 shows a system configuration of the third embodiment. Reference numeral 116 denotes a hierarchical-coding conversion processing unit that converts an input registration image into hierarchical code, and the other elements are the same as those of FIG. 1.

The hierarchical-coding conversion processing unit 116 hierarchically encodes the input registration image data 112. Since image data are generally compressed, they are hierarchically encoded after being decoded and decompressed.

As a hierarchical coding method, for example, a standard method ((part 1), ISO, IS15444-1) of JPEG-2000 is used in the embodiment of the present invention. Next, the encoding method and the progressive order of JPEG-2000 part 1 (hereinafter referred to as JPEG-2000) are briefly described.

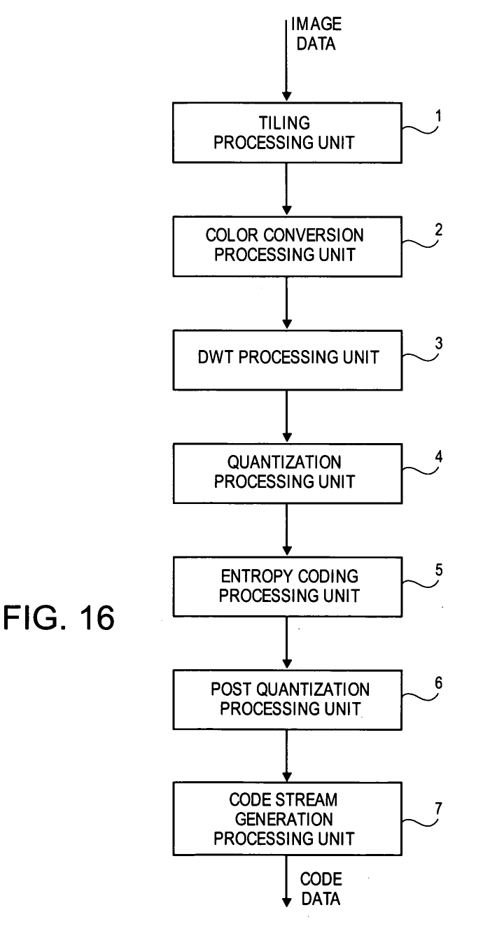

FIG. 16 shows a block diagram of the compression encoding processing with JPEG-2000. A description is made of an example of input image data of red, green, and blue (hereinafter referred to as RGB) in color. Input image data of RGB are divided into rectangular block units called tiles by a tiling processing unit 1. If raster-type image data are input, raster/block conversion processing is performed by the tiling processing unit 1. With JPEG-2000, it is possible to independently perform encoding and decoding for each tile, reduce the amount of hardware as long as encoding and decoding are performed by the hardware, and decode only a necessary tile in order to be displayed. The tiling is optional in JPEG-2000. However, if the tiling is not performed, the number of tiles is regarded as 1.

Then, the image data are converted into a luminance/color difference signal by a color conversion processing unit 2. In JPEG-2000, two color conversions are defined according to the types (5×3 and 9×7) of a filter used in the Discrete Wavelet Transform (hereinafter referred to as DWT). Prior to the color conversion, a DC level shift is applied to each of the signals of RGB.

After the color conversion, the DWT is applied to the signal for each component by the DWT processing unit 3 to output wavelet coefficients for each component. The DWT is two-dimensionally performed. However, it is generally performed based on the convolution of a one-dimensional filter calculation using a calculation method called lifting calculation.

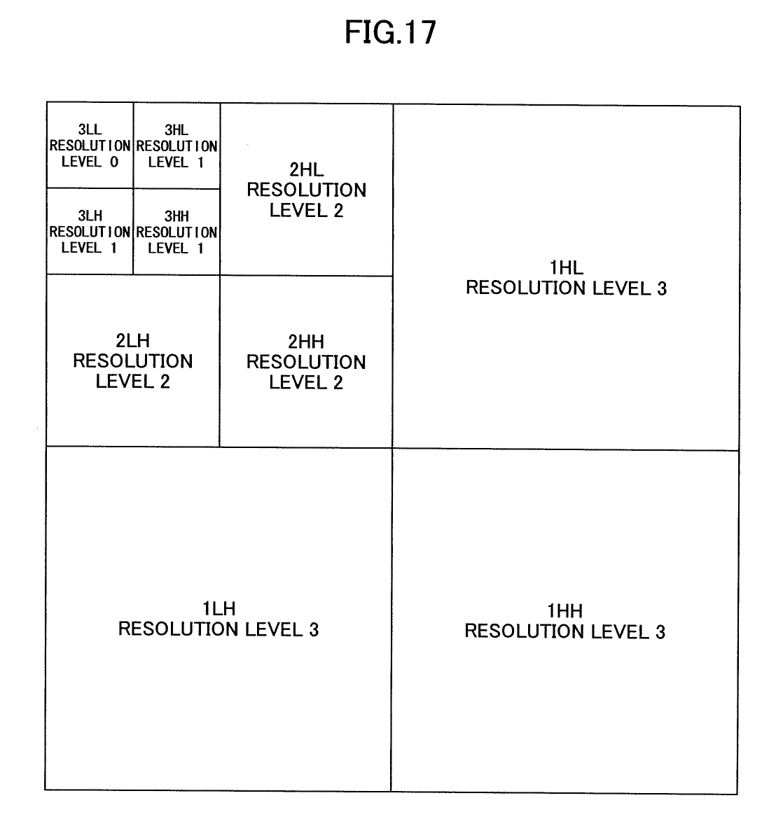

FIG. 17 shows octave-division wavelet coefficients. The DWT outputs four directional components of LL, HL, LH, and HH called sub-bands for each decomposition level and recursively performs the DWT with respect to the LL sub-band to increase the decomposition level to lower resolution. The coefficients of one decomposition level of the highest resolution are represented as 1HL, 1LH, and 1HH, and those of lower resolution are represented as 2HL, 2LH and nHH. FIG. 17 shows an example in which the resolution is divided into three decomposition levels. On the other hand, the resolution level is called 0, 1, 2, 3 in the order from the coefficient of lower resolution in the direction opposite to the decomposition levels.

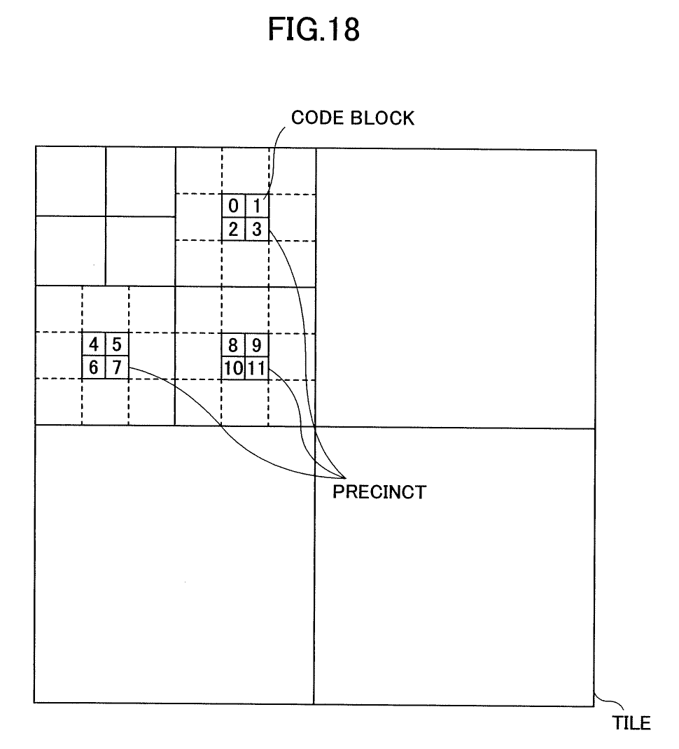

The sub-band at each decomposition level can be divided into areas called precincts where the aggregation of codes is formed. Furthermore, encoding is performed for each predetermined block called a code block. FIG. 18 shows a relationship between the tile, the precinct, and the code block in the wavelet coefficient of the tile.

Scalar quantization is applied to the wavelet coefficients output from the DWT processing unit 3 by a quantization processing unit 4. However, if lossless transformation is applied to the wavelet coefficient, the scalar quantization is not applied thereto or the wavelet coefficient is quantized as “1.” Furthermore, almost the same effect as the quantization is obtained in the below-described post quantization processing. The scalar quantization allows for the change of parameters for each tile.

Entropy encoding is applied to the quantization data output from the quantization processing unit 4 by an entropy coding processing unit 5. The entropy encoding method of JPEG-2000 divides (or does not divide the sub-band if the size of a sub-band area is smaller than or equal to that of a code block area) the sub-band into rectangular areas called code blocks and performs encoding for each block.

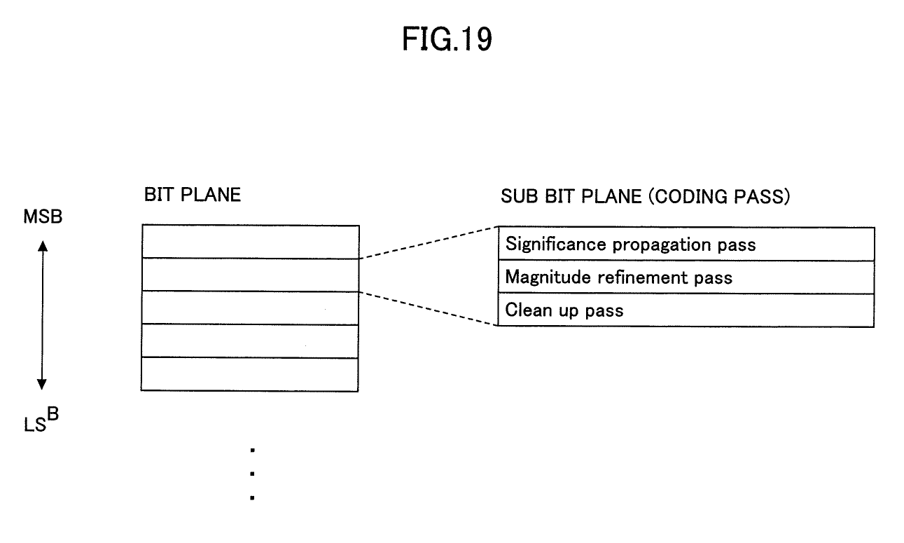

Furthermore, the data of the code block are decomposed into bit planes as shown in FIG. 19. Then, each of the bit planes is divided into three passes (Significance propagation pass, Magnitude refinement pass, and Clean up pass) in accordance with the influence of the conversion coefficient on image quality and individually encoded by an arithmetic coding system called an MQ-coder. The bit plane has greater importance (degree of contribution to image quality) on the side of MSB. On the other hand, the encoding passes are in the ascending order of importance from the Clean up pass, Magnitude refinement pass, and the Significance propagation pass. Furthermore, the terminal of each pass is also called a truncation point, which is a truncatable unit of code in the following post quantization processing.

The entropy-encoded code data are subjected to code truncation processing as needed by the post quantization processing unit 6. If it is necessary to output a lossless code, the post quantization processing is not performed. JPEG-2000 allows for the truncation of a code amount after the encoding and provides a configuration (one-pass encoding) of eliminating the feedback to control the code amount as the characteristic thereof. In a code stream generation processing unit 7, the code data after the post quantization processing are subjected to processing in which the codes are sorted in accordance with a predetermined progressive order (decoding order of the code data) and a header is added, thereby completing a code stream for the corresponding tile.

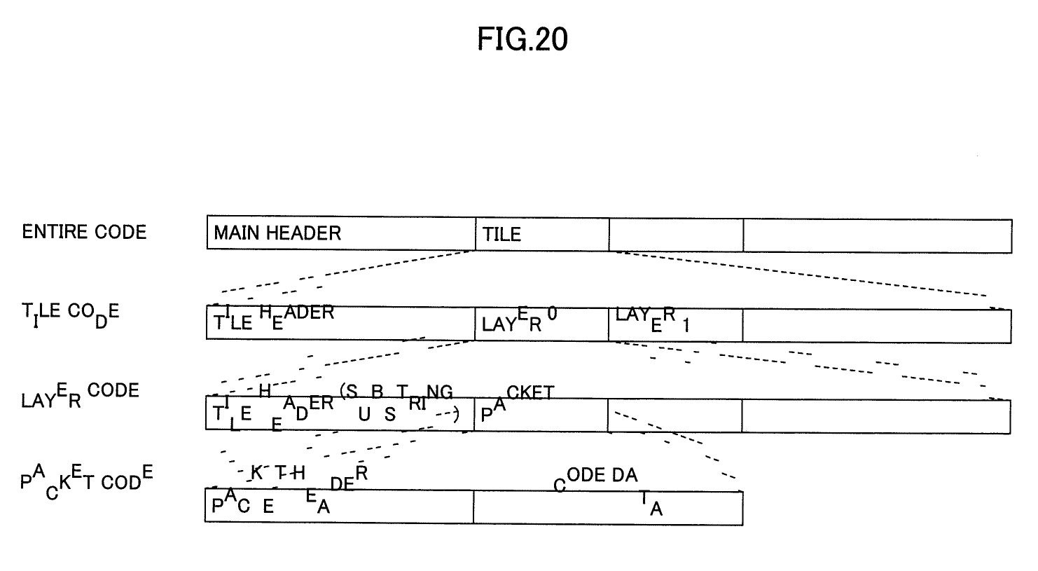

FIG. 20 shows the entire code stream by the layer progression of JPEG-2000. An entire code stream is composed of a main header and plural tiles formed by dividing an image. A tile code stream is composed of a tile header and plural layers formed by partitioning the code of a tile into the code unit (as is specifically described later) called a layer, and the plural layers are arranged in the ascending order from layer 0, layer 1, . . . . A layer code stream is composed of a layering tile header and plural packets. A packet is composed of a packet header and code data. The packet is the minimum unit of the code data and formed of the code data of one layer of a precinct at one resolution level (decomposition level) of a tile component.

Next, a description is made of the progressive order of JPEG-2000. In JPEG-2000, the following five progressions are defined by changing the priority of four image elements of image quality (layer (L)), resolution (R), component (C), and position (precinct (P)).

(LRCP Progression)

Decoding is performed in the order of the precinct, the component, the resolution level, and the layer. Accordingly, the image quality of an entire image is improved as a layer index increases, so that the progression of the image quality can be achieved. This is also called a layer progression.

(RLCP Progression)

Decoding is performed in the order of the precinct, the component, the layer, and the resolution level. Accordingly, it is possible to achieve the progression of the resolution.

(RPCL Progression)

Decoding is performed in the order of the layer, the component, the precinct, and the resolution level. Accordingly, it is possible to achieve the progression of the resolution as in the case of RPCL progression. However, it is also possible to increase the priority at a specific position.

(PCRL Progression)

Decoding is performed in the order of the layer, the resolution level, the component, and the precinct. Accordingly, the decoding at a specific position is prioritized, so that the progression of a space position can be achieved.

(CPRL Progression)

Decoding is performed in the order of the layer, the resolution level, the precinct, and the component. Accordingly, for example, it is possible to achieve the progression of the component like a case in which a gray image is first reproduced when the progressive decoding is applied to a color image.

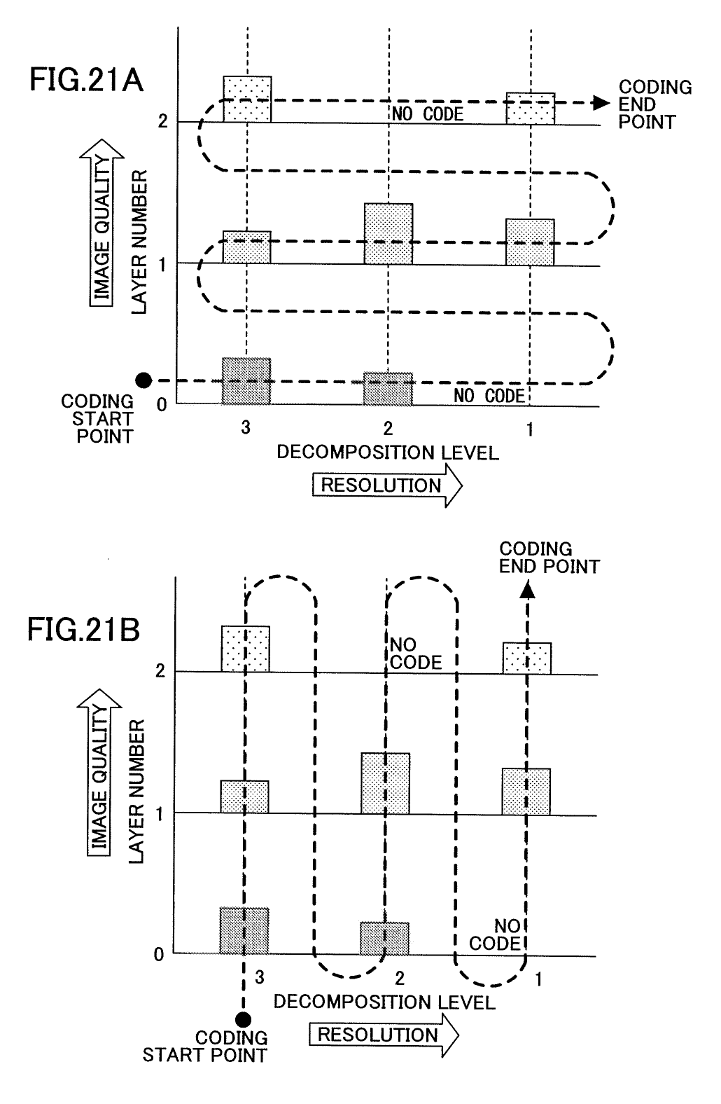

FIGS. 21A and 21B schematically show the progressive order of the LRCP progression (hereinafter referred to as layer progression) and that of the RLCP progression or the RPCL progression (hereinafter referred to as resolution progression), respectively. In FIGS. 21A and 21B, the horizontal axis represents decomposition levels (the higher the number is, the lower the resolution is) and the vertical axis represents layer numbers (the higher the number is, the further up the layer is positioned. A higher image quality can be reproduced by adding and decoding the code of the upper layer to the lower layer.). In FIGS. 21A and 21B, the painted (filled in) rectangular graphic forms represent codes at the corresponding decomposition level and layer, and the size thereof schematically represents the proportion of the code amount. The dotted arrows in FIGS. 21A and 21B represent a coding order.

FIG. 21A represents the coding order at decoding under the layer progression. In this case, all the resolutions of the same layer number are first decoded, and then those of the upper layer at the next level are decoded. From the viewpoint of a wavelet coefficient level, decoding is performed in the order from the high-order bit of a coefficient, thereby making it possible to achieve the progression by which image quality is gradually improved. FIG. 21B represents the coding order at decoding under the resolution progression. In this case, all the layers at the same decomposition (resolution) level are first decoded, and then those at the next decomposition (resolution) level are decoded. Accordingly, it is possible to achieve the progression by which image quality is gradually improved.

With the hierarchical coding method as represented by JPEG-2000, image data are held in the image information DB 114 and a thumbnail image is generated according to the resolution level adapted to the size of a thumbnail. Accordingly, it is possible to generate plural types of thumbnails different in resolution (size) just from the code data of an original image. FIGS. 21A and 21B show the examples of three hierarchies, but actually the provision of more hierarchies makes it possible to reduce the data transfer amount if the number of thumbnails to be displayed in the display area 307 is large. As a method of determining the number of hierarchies, it is preferable that the number of hierarchies (the number of decomposition levels) be determined to suit the size of an individual image and the size of images be substantially the same when decoding is performed at the resolution level “0.”

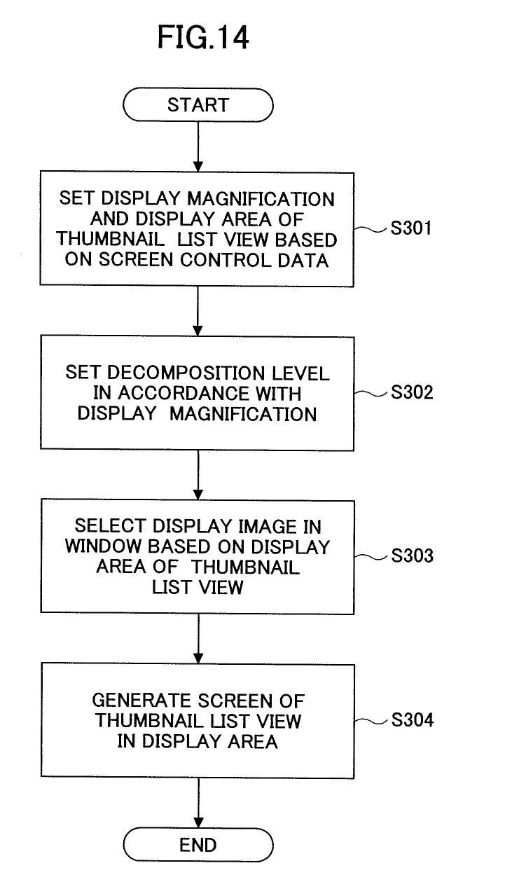

FIG. 14 shows a flowchart at the generation of a display area screen of a thumbnail list view in this embodiment. The process of step S301 is the same as that of step S201 of FIG. 7 in the first embodiment. In other words, in step S301, when the screen control data 120 are input from the client apparatus 100, the display magnification and the display area 307 of the thumbnail list view are set. For an initial screen, the server apparatus 110 sets the predetermined values thereof.

In step S302, the resolution level used for the display is set in accordance with the display magnification. In step S303, the image corresponding to the image data included in the display area 307 of the thumbnail list view is selected and determined. In step S304, a thumbnail image is generated based on the resolution level of the selected image data, and the screen of the display area of the thumbnail list view is generated.

As described above, this embodiment of the present invention provides a configuration in which a registration image is converted into hierarchical code instead of generating plural thumbnails different in size, and thumbnails different in resolution (size) are generated from the hierarchical code. Therefore, using only the code data amount of an original image makes it possible to achieve this embodiment of the present invention and reduce the data amount stored in the image information DB. Note that JPEG-2000 is used as the hierarchical coding method in this embodiment, but other hierarchical coding methods may also be used to achieve this embodiment of the present invention as a matter of course.

Although this embodiment is described using the configuration of the first embodiment as an example, it may also be applicable to the configuration of the second embodiment having the classification processing.

### Fourth Embodiment

The above embodiment describes an example of selecting the image of the display area accumulated in the image information DB 114 at the generation of the display area screen of the thumbnail list view. However, if a large number of thumbnails are to be generated, the processing may be redundant. Accordingly, this embodiment describes an example of solving the redundant processing problem.

The configuration of this embodiment is the same as that of the third embodiment. The mode of accumulating image data in the image information DB of the first through third embodiments is not particularly restricted. For example, there may be employed a type in which individual image files exist in the directory structure such as a personal computer.

In this embodiment, the image of the thumbnail list view as shown in FIG. 6B is generated using the original image data of the registration image at the image registration. In other words, the registration images 112 are pasted onto the canvas of the thumbnail list view to generate the image of the thumbnail list view. Moreover, the tiling is performed for each registration image.

FIG. 15 shows each registration image and tiles. The dotted lines of FIG. 15 indicate the boundaries between the tiles. It is not necessary to make one tile for each registration image. That is, the tile may be further divided into plural tiles inside the dotted lines of FIG. 15. By making the thumbnail list view 302 configured to be one image data group in this manner, it is possible to generate the thumbnail list view of the display area 307 with very simple processing. This is because the display area 307 serves as the area coordinates on the “thumbnail list view image” per se, and so the thumbnail list view image may be cut out in the display area 307 in order to be used as the screen of the display area. Accordingly, it is possible to eliminate step S303 in the flowchart of generating the display area screen of the thumbnail list view in FIG. 14.

As described above, this embodiment makes the thumbnail list view be processed as one image data group, to thereby simplify the processing at the generation of the display area screen. As a result, it is possible to reduce the time required for an image to be displayed on the screen and improve search efficiency. Furthermore, since the tiling is performed for each registration image in this embodiment, it is possible to easily cut out the “thumbnail list view image” for each registration image, further simplify the processing, and facilitate the processing for each registration image. For example, even when each registration image is sorted on the thumbnail list view screen, it is possible to achieve the processing just by rewriting header information.

The present invention is not limited to the specifically disclosed embodiments, and variations and modifications may be made without departing from the scope of the present invention.

The present application is based on Japanese Priority Patent Applications No. 2006-304012, filed on Nov. 9, 2006, and No. 2007-116070, filed on Apr. 25, 2007, the entire contents of which are hereby incorporated by reference.

What is claimed is:

1. An image processing apparatus to generate a list display screen for displaying a thumbnail, wherein the list display screen comprises:
a thumbnail list view of which display magnification is changeable;
a list view window for displaying at least part of the thumbnail list view; and
a plurality of the thumbnails of which size or resolution is changeable in accordance with the display magnification.

2. The image processing apparatus according to claim 1, wherein
the plurality of thumbnails are arranged based on a predetermined condition so that the thumbnail list view is generated.

3. The image processing apparatus according to claim 2, wherein
the predetermined condition refers to any one of a classification, a date, and an ID order.

4. The image processing apparatus according to claim 1, wherein
the thumbnails are generated based on a certain code of hierarchically-coded compressed image data.

5. The image processing apparatus according to claim 1, wherein
a screen of the thumbnail list view is accumulated as at least one image data group, and the list display screen is generated based on the at least one image data group.

6. The image processing apparatus according to claim 1, wherein
the list display screen is generated based on the thumbnails included in the list view window.

7. An image processing method for generating a list display screen for displaying a plural thumbnail, wherein the generation of the list display screen comprises:
generating a thumbnail list view of which display magnification is changeable;
generating a list view window for displaying at least part of the thumbnail list view; and
generating a plurality of the thumbnails of which size or resolution is changeable in accordance with the display magnification.

8. The image processing method according to claim 7, wherein
the plurality of thumbnails are arranged based on a predetermined condition so that the thumbnail list view is generated.

9. The image processing method according to claim 8, wherein
the predetermined condition refers to any one of a classification, a date, and an ID order.

10. The image processing method according to claim 7, wherein
the thumbnails are generated based on a certain code of hierarchically-coded compressed image data.

11. The image processing method according to claim 7, wherein
a screen of the thumbnail list view is accumulated as at least one image data group, and the list display screen is generated based on the at least one image data group.

12. The image processing method according to claim 7, wherein
the list display screen is generated based on the thumbnails included in the list view window.
